(19) United States
(12) Patent Application Publication
(10) Pub. No.: US 2019/0039687 A1
(43) Pub. Date: Feb. 7, 2019

(54) E-Bike Frame

(71) Applicant: Canyon Bicycles GmbH, Koblenz (DE)

(72) Inventors: Lorenz Lay, Koblenz (DE); Vincenz Thoma, Koblenz (DE)

(21) Appl. No.: 16/053,071

(22) Filed: Aug. 2, 2018

(30) Foreign Application Priority Data
Aug. 3, 2017 (DE) 20 2017 004 040.9

(51) Int. Cl. B62M 6/55; B62K 19/40; B62K 19/36; B62K 19/34; B62M 6/90; B62K 19/02; B62K 25/28

(52) U.S. Cl. CPC B62M 6/55; B62K 19/40; B62K 19/36; B62L 1/00; B62M 6/90; B62K 19/02; B62K 25/28; B62K 19/34

(57) ABSTRACT

An e-bike frame includes a top tube, a downtube and a seat tube. Further, a bottom bracket is arranged in a housing which may be a bottom bracket receptacle element. An electric motor is also provided in the housing. A battery is connected with the downtube. A channel element is arranged laterally beside the battery. The same serves to receive wires, shift cables, brake cables and/or hydraulic lines.

### CROSS-REFERENCE TO RELATED APPLICATION

This application claims priority to German Utility Model Application No. 20 2017 004 040.9 filed Aug. 3, 2017, the disclosure of which is hereby incorporated in its entirety by reference.

### BACKGROUND OF THE INVENTION

### Field of the Invention

The disclosure relates to an e-bike frame, in particular an e-bike frame for mountain bikes.

### Description of Related Art

Bicycle frames with an electric motor, so-called e-bikes, which also include so-called pedelecs, include an electric motor that is usually connected with the bottom bracket. The battery necessary for the operation of the electric motor may be arranged in the region of the rack, in the region of a seat tube, as well as in the region of a downtube of the bicycle frame. It is advantageous to arrange the battery in the region of the downtube, since a relatively low center of gravity of the bicycle can be guaranteed thereby. This is extremely important for driving dynamics. On the other hand, arranging the battery in the region of the downtube, e.g. on the downtube, has the disadvantage that it is difficult to place wires, hydraulic lines and in particular shift cables, such as Bowden cables. In particular with shift cables, it is necessary to place these with radii as small as possible. In case of narrow radii, damages can occur. Specifically, wear is increased and the functional reliability is possibly not guaranteed.

### SUMMARY OF THE INVENTION

It is an object of the disclosure to provide an e-bike frame having a favorable center of gravity and in which the placing of wires, lines and/or cables is improved.

The e-bike frame of the present disclosure includes a downtube as well as a top tube connected therewith, if so provided. The bicycle frame may possibly be designed e.g. as a low step-through frame or a lady's trekking bike and as such may not have a top tube. The connection between the downtube and the possibly provided top tube is preferably made via a head tube. The head tube serves to receive a steer tube connected with the fork. The bicycle frame further includes a seat tube. The seat tube may be indirectly or directly connected with the downtube. Possibly, an immediate connection may be made between the seat tube and the downtube via a bottom bracket receptacle or a motor receptacle. The seat tube is usually connected with the top tube and preferably serves to receive a seat post supporting a seat.

In a particularly preferred aspect, the e-bike frame further includes a bottom bracket receptacle. The same serves to receive the bottom bracket. The bottom bracket includes a pedal crank connected with the pedals. Here, the bottom bracket is preferably indirectly or directly connected with the down tube and/or is connected indirectly or directly with the seat tube. In addition, an electric motor can be provided which is connected with the bottom bracket in particular via gears or a toothed belt. Here, a motor housing or a motor receptacle may be connected with the bottom bracket receptacle element or may be formed integrally with the same. Further, the motor housing may be indirectly or directly connected with the down tube and/or may be connected indirectly or directly with the seat tube.

In a preferred development, the bottom bracket is part of a motor assembly including the electric motor. If the bottom bracket is part of a motor assembly including the electric motor, it is particularly preferred that the motor assembly is connected with the downtube and/or the seat tube via a motor receptacle.

In all previously described preferred aspects it is particularly preferred that a strong connection exists between the downtube and the bottom bracket receptacle or the motor receptacle, so that a rigid unit is formed thereby. Here, it is further preferred that, in particular, also the channel element is fixedly connected with the bottom bracket receptacle or the motor receptacle. Specifically, the channel element is connected with an upper side of the bottom bracket receptacle or the motor receptacle, and the downtube is connected with a front or bottom side of the bottom bracket receptacle or the motor receptacle. The bottom bracket receptacle or the motor receptacle is thus supported on two sides by the channel element, and is in particular fixedly connected with these two components. In this manner, a rigid design of the bicycle frame is realized, and in particular a good force transmission from the motor assembly, i.e. the unit of the bottom bracket and the electric motor, to the bicycle frame is guaranteed.

Instead of an electric motor connected with the bicycle frame, it is also possible to provide a hub motor, in particular a hub motor integrated in the rear wheel, to drive the e-bike.

Further, the bicycle frame is configured for connection with a battery. Here, the battery is either connected directly with the down tube or a corresponding battery receptacle is provided that is connected with the downtube. The battery can be detached from the battery receptacle in particular for charging purposes. By arranging the battery in the region of the downtube, a relatively low center of gravity is realized. Here, the battery can be connected with an upper side, a lower side or also a side surface of the downtube. In order to realize a center of gravity as low as possible, it is further preferred that the battery or the battery receptacle is arranged close to the bottom bracket receptacle or the motor receptacle, in particular immediately adjoining the same.

According to the disclosure, the e-bike frame has a channel element arranged laterally beside the battery or laterally beside a battery receptacle. The channel element serves to receive electric wires, shift cables and brake cables and/or hydraulic lines or the like. Using such a channel element allows an advantageous arrangement of the corresponding wires, lines or cables. It is also possible to provide the immediate electric contact for the battery at this site.

In a particularly preferred aspect of the e-bike frame, the channel element is configured such that it serves to reinforce the bicycle frame. For this purpose, the channel element is fixedly connected with the down tube or is integrally formed with the same. In particular, the channel element is made of the same as the downtube or a similar material. The channel element extends preferably over more than half the length of the downtube. Thus, a corresponding reinforcement can be achieved. It is preferred that the channel element extends over at least two thirds of the downtube length, in particular over the entire length of the downtube. Here, it is preferred that the channel element is connected with the top tube and/or the head tube at its upper and with the bottom bracket receptacle or the motor receptacle at its lower end.

For a further enhancement of the reinforcement it is particularly preferred that the channel element has a closed, e.g. substantially rectangular cross section. Here, a lower side of the closed cross section can be formed by the downtube. It is further preferred that also the downtube has a closed cross section.

The wires, lines and/or cables arranged in the channel element are preferably arranged substantially vertically one above the other, so that the channel element can be of a relatively small width. Specifically, the channel element has a width of 4-15, in particular 4-12 mm. The height of the channel element depends in particular on the number of the wires, cables or lines arranged in the channel element and preferably is 15-50 mm, in particular 25-45 mm.

Further, it is possible to arrange a conductor path element in the channel element, instead of electric lines. This also allows for a simple electric connection with the battery.

In another, particularly preferred aspect of the e-bike frame of the disclosure, a centerline of the downtube extends below the bottom bracket and preferably below the bottom bracket receptacle. Due to such a low arrangement of the downtube, it is also possible to provide a low arrangement of the battery or the battery receptacle. Specifically, the centerline of the downtube extends at a vertical distance from the bottom bracket, i.e. the centerline of the bottom bracket, of at least 5 cm, in particular at least 10 cm and particularly preferred at least 15 cm.

In a further preferred aspect a reinforcing element is provided in addition to the channel element. The reinforcing element is preferably arranged opposite the channel element, i.e. on the opposite side of the battery. The reinforcing element is preferably fixedly or integrally connected with the downtube. In particular, a symmetric design of the downtube, together with the channel element and the reinforcing element, is thereby realized with respect to a central plane of the downtube or the bicycle frame. The reinforcing element is preferably designed in a manner corresponding to the channel element and preferably also extends over the same length of the downtube as the channel element. In particular, the reinforcing element is also hollow and can thus also serve to receive wires, cables or lines.

Further, it is preferred that the channel element and/or the reinforcing element are connected with the bottom bracket receptacle. In particular, a connection with an upper side of the bottom bracket receptacle is made. In this respect, the channel element and/or the reinforcing element extend above the bottom bracket receptacle. By this connection, it is possible to realize a further reinforcement. Possibly, the channel element and/or the reinforcing element is therefore additionally connected with the motor housing or is connected with the same instead of the connection with the bottom bracket receptacle element.

Since the e-bike frame of the invention is in particular a bicycle frame of a mountain bike, the bicycle frame has a rear frame structure, in particular a swivel-mounted rear frame structure. In this regard, it is particularly preferred that the wires, lines or cables are arranged close to a main link bearing of the rear frame structure. Specifically, the wires, lines or cables are arranged at a distance of less than 5 cm, in particular less than 2 cm from the rotary axis of the main link bearing. This has the advantage that, when the rear frame structure is compressed or bounces, the corresponding wires, cables or lines are stressed less. The main link bearing is the bearing with which the chainstays, i.e. the lower stays of the rear frame structure, are usually connected. Preferably, the main link bearing is connected with the bottom bracket receptacle element and/or the seat tube.

### BRIEF DESCRIPTION OF THE DRAWINGS

The disclosure will be described in detail hereinafter with reference to a preferred aspect and to the accompanying drawings.

In the Figures:

FIG. 1 is a schematic side view of an aspect of an e-bike frame according to the present disclosure,

FIG. 2 is a schematic sectional view along line II-II in FIG. 1, and

FIGS. 3a and b are schematic sectional views of alternative aspects, corresponding to the sectional view shown in FIG. 2.

### DESCRIPTION OF THE INVENTION

The e-bike frame illustrated includes a top tube 10, a downtube 14 connected with the top tube 10 via a head tube 12, as well as a seat tube 16. The seat tube 16 is connected with the top tube 10 via a connecting element 18. Further, the seat tube 16 is connected with a housing 20. In the aspect illustrated, the housing 20 serves both as a bottom bracket receptacle element receiving a bottom bracket 22 and as a housing for an electric motor 24. In the particularly preferred aspect illustrated, the housing 20 is thus formed as a common housing for the motor assembly which in particular includes the bottom bracket 22 and the electric motor 24, as well as an interposed transmission, gears and the like, if provided.

Further, the seat tube 16 is connected with a rear frame structure 26. Since the bicycle frame illustrated is in particular a mountain bike frame connected with a sprung rear frame structure 26, the chainstays 28 of the rear frame structure 26 are connected with the seat tube 16, as well as with the housing 20 via a main link bearing 30.

Further, the seat stays 32 of the rear frame structure 26 are connected with a damper element 38 via further hinges 34 36, as well as a corresponding rocker, the damper element being arranged at the top tube in the aspect illustrated. Of course, conventional other arrangements of the damper element and other designs of the rear frame structure are possible.

A battery 40 is connected witch an upper side of the downtube 14. This is typically realized by means of a battery receptacle, so that the battery can be removed in particular for charging.

The downtube 14, which is preferably indirectly or directly connected with the housing 20 in particular in a fixed manner, has an open end in the aspect illustrated, i.e. other than conventionally often the case, the downtube 14 is not connected with the seat tube 16. Rather, a connection between the downtube 14 and the seat tube 16 is effected exclusively via the housing 20, as well, if so provided, also via the channel element 42 arranged above the housing 20.

A channel element 42 is arranged laterally beside the battery 40. The channel element 42 is fixedly connected with the downtube 14 or formed integrally with the same. Further, in the aspect illustrated, the channel element 42 extends over more than two thirds of the downtube length. Further, in the embodiment illustrated, the channel element 42 extends above the housing 20, i.e. above the bottom bracket receptacle element, as well as above the motor housing. Moreover, the channel element 42 is fixedly connected with an upper side of the housing 20. Besides, the channel element 42 is possibly also connected with the seat tube 16 in the region of the main link bearing 30.

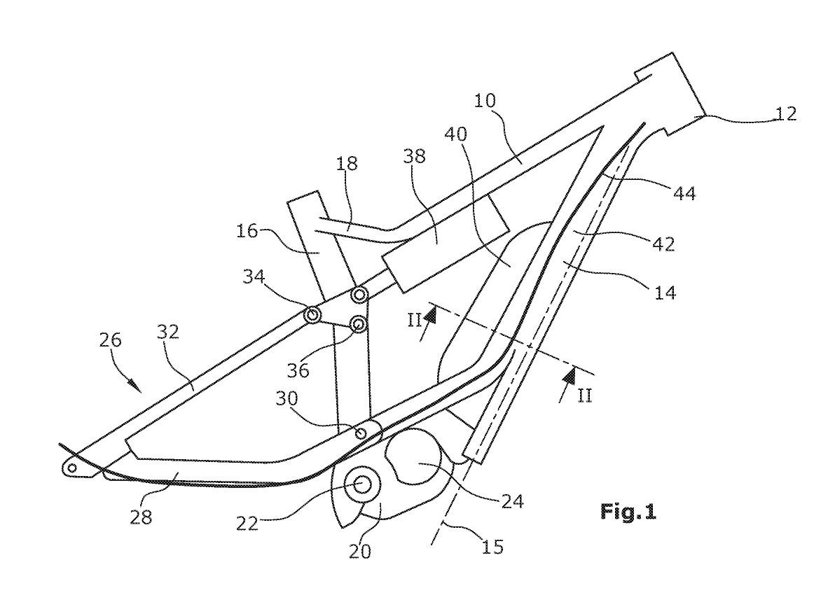

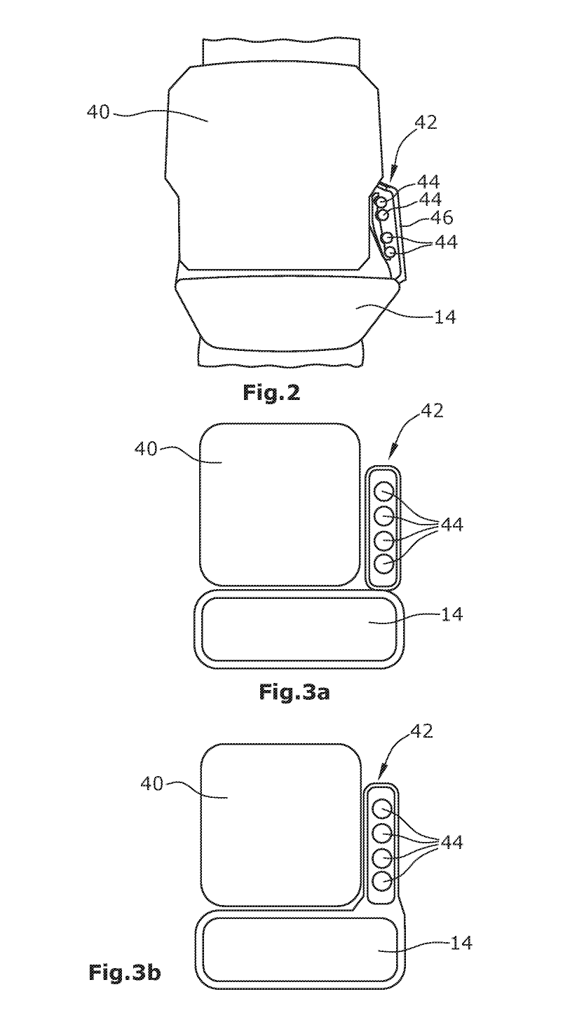

Electric lines, hydraulic lines and/or Bowden cables 44 are provided inside the channel element 42, in particular in a vertically stacked arrangement (FIG. 2). In FIG. 1, one of the lines 44 is illustrated as a black line. The line 44 extends in the channel element 42 and can thus be arranged in particular above the housing 20. Further, the line 44 or the like extends near the main link bearing so that correspondingly slight bends act on the line and the like. The lines, which in particular extend towards the rear frame structure 26, are e.g. hydraulic brake lines, Bowden cables for a brake or a gear shift, as well as electric lines for a gear shift or a lighting or the like.

In the aspect illustrated in FIG. 2, the channel element 42 is formed substantially by an element 46 open to the battery 40. The same is fixedly connected with the downtube 14. The individual wires, hydraulic lines 44 etc. can be fixed in the element 46 of the channel element 42 using corresponding holder elements.

Further, the downtube 14 is arranged such that a centerline 15 of the downtube extends below the bottom bracket 22. Specifically, the centerline 15 extends below the housing 20 accommodating the bottom bracket 22. The vertical distance is preferably greater than 5 cm, in particular greater than 10 cm and particularly preferred greater than 15 cm.

As schematically illustrated in FIGS. 3a and 3b, the channel element 42 may also have a cross section that is closed in itself, in particular substantially rectangular. The same may be connected with the downtube 14 likewise having a closed cross section (FIG. 3a) or may be formed integrally with the same.

A reinforcing element. preferably designed corresponding to the channel element 42, could be provided in addition on the left side in FIG. 3a or 3b. In this case, the battery would possibly be somewhat narrower.

While several examples of an e-bike frame were shown in the accompanying figures and described in detail hereinabove, other examples will be apparent to, and readily made by, those skilled in the art without departing from the scope and spirit of the disclosure. Accordingly, the foregoing description is intended to be illustrative rather than restrictive. The apparatus of the present disclosure described hereinabove is defined by the appended claims and all changes to the disclosed apparatus that fall within the meaning and range of equivalency of the claims are to be embraced within their scope.

1. An e-bike frame comprising
a downtube,
a seat tube connected with the downtube, and
a battery connected with the downtube,
wherein
a channel element arranged laterally beside the battery is provided for receiving at least one of the following: electric wires, shift cables, brake cables, and hydraulic lines.

2. The e-bike frame of claim 1, wherein a bottom bracket is arranged in a bottom bracket receptacle and is connected with an electric motor.

3. The e-bike frame of claim 2, wherein the bottom bracket is part of a motor assembly comprising the electric motor.

4. The e-bike frame of claim 3, wherein the motor assembly is connected with the downtube, the seat tube, or the downtube and seat tube via a motor receptacle.

5. The e-bike frame of claim 1, wherein the downtube is connected with a head tube, the head tube being connected with a top tube, the top tube being connected with the seat tube.

6. The e-bike frame of claim 1, wherein the channel element is fixedly connected or formed integrally with the downtube to reinforce the bicycle frame.

7. The e-bike frame of claim 1, wherein the channel element has a closed cross section.

8. The e-bike frame of claim 1, further comprising a reinforcing element arranged opposite the channel element, which reinforcing element is fixedly connected or formed integrally with the downtube.

9. The e-bike frame of claim 1, wherein a plurality of at least one of the following:
wires, lines, and Bowden cables are arranged vertically one above the other in the channel element.

10. The e-bike frame of claim 1, wherein a conductor path element is arranged in the channel element for the electric connections.

11. The e-bike frame of claim 1, wherein a centerline of the downtube extends at a vertical distance of at least 5 cm.

12. The e-bike frame of claim 1, wherein the channel element is connected with the bottom bracket receptacle element.

13. The e-bike frame of claim 4, wherein the channel element is connected with the motor receptacle.

14. The e-bike frame of claim 1, wherein the bicycle frame has a swivel-mounted rear frame structure.

15. The e-bike frame of claim 1, wherein at least one of the following: wires, lines, and Bowden cables leading to the rear frame structure are arranged close to a main link bearing of the rear frame structure, the main link bearing being connected with the bottom bracket receptacle element, the seat tube, or the bottom bracket receptacle element and the seat tube.
